(19) United States
(12) Patent Application Publication
(10) Pub. No.: US 2025/0202806 A1
(43) Pub. Date: Jun. 19, 2025

(54) INTENT-BASED APPLICATION STEERING USING SD-WAN ROUTER AFFINITY

(71) Applicant: Cisco Technology, Inc., San Jose, CA (US)

(72) Inventors: Hari Krishna Donti, Dublin, CA (US); Deepthi Tammireddy, Dublin, CA (US); Sanjay Sreenath, San Jose, CA (US); Pritam Baruah, Fremont, CA (US); Satish Kumar Mahadevan, San Ramon, CA (US); Avinash Shah, Pleasanton, CA (US)

(21) Appl. No.: 18/430,209

(22) Filed: Feb. 1, 2024

Related U.S. Application Data
(60) Provisional application No. 63/609,845, filed on Dec. 13, 2023.

(51) Int. Cl. H04L 45/302; H04L 9/40; H04L 45/76

(52) U.S. Cl. CPC H04L 45/306; H04L 45/76; H04L 63/02

(57) ABSTRACT

This disclosure describes techniques and mechanisms for enabling intent-based application traffic steering in a network. The techniques may enable a controller to resolve affinity in data policies with TLOC lists and user intent. The techniques may enable branches to apply local affinity preference orders and data policies when routing traffic. The techniques enable network administrators to create and apply a single data policy across branches of a network, such that regardless of the number of hubs or the number of branches, the techniques described herein create just one data policy (e.g., a centralized data policy), resulting in significant simplification of the network configuration to be created, managed, and/or deployed.

### CROSS REFERENCE TO RELATED APPLICATIONS

This application claims priority to U.S. Provisional Patent Application No. 63/609,845, filed Dec. 13, 2023, the entire contents of which are incorporated herein by reference.

### TECHNICAL FIELD

The present disclosure relates generally to the field of computer networking, and more particularly to enabling intent-based application traffic steering in SD-WANs.

### BACKGROUND

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of networks, such as Local-Area Networks (LANs) that are in one physical location such as a building, Wide-Area Networks (WANs) that extend over a large geographic area to connect individual users or LANs, Enterprise Networks that are built for a large organization, Internet Threat and compliance data provider (ISP) Networks that operate WANs to provide connectivity to individual users or enterprises, software-defined networks (SDNs), wireless networks, core networks, cloud networks, software defined WANs (SD-WANs), and so forth.

In SD-WANs, affinity is a routing construct utilized in OMP control policies to facilitate symmetric routing. Affinity groups enable the specification of the preferred order among multiple next hops for a traffic flow. This function is employed when a router needs to determine the next hop for a flow, and multiple routers within a Multi-Region Fabric architecture can serve as the next hop. Configuring this functionality involves assigning a router affinity group ID (ranging from 1 to 63) on a router and establishing the order of preference for choosing the next hop, which is defined as a list of affinity group IDs. When the Overlay Management Protocol (OMP) operates on a router to determine the best path for a flow, the OMP may consider the routers advertising the prefix for the flow's destination. From these potential next-hop routers, OMP considers the affinity group preferences to prioritize and choose the best path, ensuring more efficient traffic steering. OMP may advertise potential routes to branches based on affinity. To govern the best path concerning application, source/destination, port, DSCP, or packet length, users must create data policies specifying matching criteria and actions as a set of remote transport locators (TLOCs) with TLOC preferences or Service-chain chain action which in turn gets resolved to set of remote TLOCs by a controller.

Within the packet path, packets undergo inspection by applying data policies and application-aware routing (AAR) policies. When specific application traffic matches a rule in one of the data policies or AAR policies, the traffic is constrained to the TLOC with the highest TLOC-preference. However, packet path decisions rely solely on TLOC preferences, leading to a situation where a single policy cannot serve multiple sites. Thus, multiple data policies are necessary with differing preferences, requiring the maintenance of various TLOC lists and policies. The proliferation of TLOC lists within policies results in cumbersome bookkeeping, which is undesirable. This issue exacerbates when dealing with multiple hubs, leading to an explosion in the proliferation problem.

To further illustrate, a SD-WAN and may utilize a hub and spoke model. For instance, the network may have an east coast hub and a west coast hub along with an east coast branch and a west coast branch. Each hub may host a service chain. In order to enable the east and west coast branches to access an application, the data traffic may need to undergo and/or pass through the service chain at one of the hubs. In this example, a data policy is applied to the east and west coast branches in order to steer data traffic.

However, in order to perform traffic steering using data policies, users (network administrators, etc.) need to bookkeep TLOC's across the network and are required to create multiple policies. For instance, to direct specific application traffic to chosen remote locations, users must explicitly set TLOC preferences to prioritize one path over another. Control policy is unsuitable as it lacks the ability to match on application traffic or source/destination.

This requires network administrators to record TLOCs from each HUB/remote location and organize them into distinct TLOC lists with respective preferences. Users must generate diverse policies for various sites and assign different TLOC lists to them. However, managing multiple hubs leads to an issue with an increasing number of TLOC-lists and policies, posing a significant challenge in network administration. To achieve the above intent, the user needs to book keep the TLOCs of each HUB and configure it in data policy, as shown in above picture. In this example, 2 data policies are needed each for West and East branches. In a scaled topology, this is impractical, repetitive, and difficult to maintain. For instance, when dealing with multiple hubs, this leads to an explosion in the proliferation problem. For example, with 8 hubs and 8 sets of branches, we'll need 8 different data policies and 8 different TLOC lists. This proliferation makes managing the network quite cumbersome involving a lot of bookkeeping, which is undesirable.

Moreover, current techniques provide inconsistent support of affinity in traffic steering. For instance, affinity is supported in routing policies, however, affinity is ignored in data policies. Affinity group and affinity preference order support exists in OMP routing protocol, however, this is purely based on destination prefixes and choosing next-hop is based on preference order configured at the branch. Not honoring the system affinity configuration in data policy and AAR policy leads to confusing and contradicting outcomes. The absence of support for affinity in data policies restricts the potential use cases for managing data effectively. Without affinity group support in data policy, it is an administrative challenge to steer application traffic according to the intent.

Additionally, traffic steering based on TLOC preference is static in nature for the entire overlay, without granular per local device control. That is, there is currently no way for a site to exert local control over application traffic steering based on its preferences, rather than adhering to the TLOC preferences advertised by the central hub. That is, there is no per branch device local preference control. Accordingly, in the example described above, both the East and west branches may prefer the east hub, which goes against the user intent of choosing a co-located hub.

Further, current techniques lack finer control on application traffic steering. For instance, combinations of router affinity, local and remote TLOC preferences, and service level agreement (SLA) criteria make it difficult to enable finer control. Control policies, which support affinity, is route specific and can't match on application traffic. Data policies can match on application and actions with local color, remote TLOC preference explicitly configured and AAR with SLA, however, current techniques do not enable data policies to be applied

Accordingly, there is a need for a comprehensive mechanism to integrate router affinity into data and AAR policies within SD-WAN networks.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a system can enabling intent-based application traffic steering in SD-WANs.

FIG. 2 illustrates an example environment associated with the system described in FIG. 1.

FIG. 3 illustrates an example environment associated with the system described in FIGS. 1-2.

FIG. 4 illustrates a flow diagram of an example method for enabling intent-based application traffic steering in SD-WANs associated with the system described in FIGS. 1-3.

FIG. 5 illustrates a flow diagram of an example method for enabling intent-based application traffic steering in SD-WANs associated with the system described in FIGS. 1-4.

FIG. 6 is a computer architecture diagram showing an illustrative computer hardware architecture for implementing a device that can be utilized to implement aspects of the various technologies presented herein.

### DESCRIPTION OF EXAMPLE EMBODIMENTS

### Overview

The present disclosure relates generally to the field of computer networking, and more particularly to enabling intent-based application traffic steering in SD-WANs.

A method to perform the techniques described herein may be implemented at least in part by a controller of a network and may include receiving, from one or more hubs within the network, data associated with the one or more hubs. The method may include receiving, from an application on a user device, instructions associated with steering traffic within the network. Further the method may include resolving, based at least in part on the data and the instructions, a centralized data policy. Additionally, the method may include sending, to a first branch within the network, the centralized data policy and sending, to a second branch within the network, the centralized data policy.

Another method to perform the techniques described herein may be implemented at least in part by a device at a branch within a network and may include receiving, from a controller of the network, a centralized data policy. The method may include identifying a local affinity preference order associated with an application or a host. Additionally, the method may include receiving traffic associated with the application or the host. The method may also include routing the traffic to a hub within the network based at least in part on the centralized data policy and the local affinity preference order.

Additionally, any techniques described herein, may be performed by a system and/or device having non-transitory computer-readable media storing computer-executable instructions that, when executed by one or more processors, performs the method(s) described above and/or one or more non-transitory computer-readable media storing computer-readable instructions that, when executed by one or more processors, cause the one or more processors to perform the method(s) described herein.

### Example Embodiments

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of networks, such as Local-Area Networks (LANs) that are in one physical location such as a building, Wide-Area Networks (WANs) that extend over a large geographic area to connect individual users or LANs, Enterprise Networks that are built for a large organization, Internet Threat and compliance data provider (ISP) Networks that operate WANs to provide connectivity to individual users or enterprises, software-defined networks (SDNs), wireless networks, core networks, cloud networks, software defined WANs (SD-WANs), and so forth.

In SD-WANs, affinity is a routing construct utilized in OMP control policies to facilitate symmetric routing. Affinity groups enable the specification of the preferred order among multiple next hops for a traffic flow. This function is employed when a router needs to determine the next hop for a flow, and multiple routers within a Multi-Region Fabric architecture can serve as the next hop. Configuring this functionality involves assigning a router affinity group ID (ranging from 1 to 63) on a router and establishing the order of preference for choosing the next hop, which is defined as a list of affinity group IDs. When the Overlay Management Protocol (OMP) operates on a router to determine the best path for a flow, the OMP may consider the routers advertising the prefix for the flow's destination. From these potential next-hop routers, OMP considers the affinity group preferences to prioritize and choose the best path, ensuring more efficient traffic steering. OMP may advertise potential routes to branches based on affinity. To govern the best path concerning application, source/destination, port, DSCP, or packet length, users must create data policies specifying matching criteria and actions as a set of remote TLOCs with TLOC preferences or Service-chain chain action which in turn gets resolved to set of remote TLOCs by a controller.

Within the packet path, packets undergo inspection by applying data policies and AAR policies. When specific application traffic matches a rule in one of the data policies or AAR policies, the traffic is constrained to the TLOC with the highest TLOC-preference. However, packet path decisions rely solely on TLOC preferences, leading to a situation where a single policy cannot serve multiple sites. Thus, multiple data policies are necessary with differing preferences, requiring the maintenance of various TLOC lists and policies. The proliferation of TLOC lists within policies results in cumbersome bookkeeping, which is undesirable. This issue exacerbates when dealing with multiple hubs, leading to an explosion in the proliferation problem.

To further illustrate, a SD-WAN and may utilize a hub and spoke model. For instance, the network may have an east coast hub and a west coast hub along with an east coast branch and a west coast branch. Each hub may host a service chain. In order to enable the east and west coast branches to access an application, the data traffic may need to undergo and/or pass through the service chain at one of the hubs. In this example, a data policy is applied to the east and west coast branches in order to steer data traffic.

However, in order to perform traffic steering using data policies, users (network administrators, etc.) need to bookkeep TLOC's across the network and are required to create multiple policies. For instance, to direct specific application traffic to chosen remote locations, users must explicitly set TLOC preferences to prioritize one path over another. Control policy is unsuitable as it lacks the ability to match on application traffic or source/destination.

This requires network administrators to record TLOCs from each HUB/remote location and organize them into distinct TLOC lists with respective preferences. Users must generate diverse policies for various sites and assign different TLOC lists to them. However, managing multiple hubs leads to an issue with an increasing number of TLOC-lists and policies, posing a significant challenge in network administration. To achieve the above intent, the user needs to book keep the TLOCs of each HUB and configure it in data policy, as shown in above picture. In this example, 2 data policies are needed each for West and East branches. In a scaled topology, this is impractical, repetitive, and difficult to maintain. For instance, when dealing with multiple hubs, this leads to an explosion in the proliferation problem. For example, with 8 hubs and 8 sets of branches, we'll need 8 different data policies and 8 different TLOC lists. This proliferation makes managing the network quite cumbersome involving a lot of bookkeeping, which is undesirable.

Moreover, current techniques provide inconsistent support of affinity in traffic steering. For instance, affinity is supported in routing policies, however, affinity is ignored in data policies. Affinity group and affinity preference order support exists in OMP routing protocol, however, this is purely based on destination prefixes and choosing next-hop is based on preference order configured at the branch. Not honoring the system affinity configuration in data policy and AAR policy leads to confusing and contradicting outcomes. The absence of support for affinity in data policies restricts the potential use cases for managing data effectively. Without affinity group support in data policy, it is an administrative challenge to steer application traffic according to the intent.

Additionally, traffic steering based on TLOC preference is static in nature for the entire overlay, without granular per local device control. That is, there is currently no way for a site to exert local control over application traffic steering based on its preferences, rather than adhering to the TLOC preferences advertised by the central hub. That is, there is no per branch device local preference control. Accordingly, in the example described above, both the East and west branches may prefer the east hub, which goes against the user intent of choosing a co-located hub.

Further, current techniques lack finer control on application traffic steering. For instance, combinations of router affinity, local and remote TLOC preferences, and SLA criteria make it difficult to enable finer control. Control policies, which support affinity, is route specific and can't match on application traffic. Data policies can match on application and actions with local color, remote TLOC preference explicitly configured and AAR with SLA, however, current techniques do not enable data policies to be applied

Accordingly, there is a need for a comprehensive mechanism to integrate router affinity into data and AAR policies within SD-WAN networks.

This disclosure describes techniques and mechanisms for enabling intent-based application traffic steering in SD-WANs. In some examples, the system may be implemented by a controller of a network. In some examples, the system may comprise receiving, from one or more hubs within the network, data associated with the one or more hubs. The system may include receiving, from an application on a user device, instructions associated with steering traffic within the network. The system may comprise resolving, based at least in part on the data and the instructions, a centralized data policy. The system may further include sending, to a first branch within the network, the centralized data policy. The system may also include sending, to a second branch within the network, the centralized data policy.

Additional techniques may be performed by a device at a branch within a network. The techniques may include receiving, from a controller of the network, a centralized data policy. The techniques may further include identifying a local affinity preference order associated with an application or a host. The techniques may include receiving traffic associated with the application or the host. The techniques may also include routing the traffic to a hub within the network based at least in part on the centralized data policy and the local affinity preference order.

In some examples, the system may configure one or more hub(s) to comprise one or more affinity group numbers. For instance, a first hub may be assigned and/or configured to have the affinity group number 1. A second hub may be assigned and/or configured to have the affinity group number 2. In some examples, each route originating from a particular hub (e.g., via a gateway, etc.) may be tagged with the configured and/or assigned affinity group number (e.g., route(s) from the first hub are tagged with the affinity group number 1, etc.). In some examples, a user may assign affinity group numbers to the one or more hub(s) during configuration of the network.

In some examples, an affinity preference order may be assigned to each branch and/or network device of each branch as an ordered list. For instance, affinity preference order(s) may be configured and/or assigned to each branch by a network administrator, such as during configuration of the network. In some examples, a first edge device may be configured to have an affinity preference order of [1,2]. In this example, the first branch is configured to prefer routing traffic to a first hub with the affinity group number 1 first. In some examples, such as in the absence of the first hub tagged with the affinity group number 1, the first branch may then failover to a second hub tagged with affinity group number 2 and so on. In some examples, a second branch may be configured to have an affinity preference order of [2,1]. In this example, the second branch is configured to prefer routing traffic to a second hub tagged with affinity group number 2 first. In some examples, such as in the absence of the second hub assigned with the affinity group number 2, the second branch may then failover to the first hub assigned with affinity group number 1 and so on. In some examples, the system may store affinity preference orders locally at each branch.

In some examples, each of the one or more hubs may host a service chain. In some examples, the service chain may comprise a firewall service. In some examples, when application is sent to and/or received from a branch, the application traffic may undergo and/or pass through the firewall service. In some examples, each of the one or more hubs comprises one or more TLOCs. In some examples, each of the one or more hubs may advertise service chain capabilities to the controller. In some examples, the advertisements may comprise TLOCs associated with each hub and affinity group numbers associated with each hub.

In some examples, the controller may generate a centralized data policy in response to receiving instructions from a user. In some examples, the instructions may be received via an application associated with a service provider (e.g., such as Cisco, via vSmart, etc.). In some examples, the instructions may comprise an indication of user intent. For instance, user intent may indicate that application traffic at a first hub and a second hub will undergo the service chain. In this example, and in contrast to existing techniques, the user does not need to specify TLOCs or data policies for each of the hubs and/or branches. Instead, the controller may configure the centralized data policy. Moreover, in contrast to existing techniques, a use does not need to define TLOCs statically and/or create multiple data policies for each branch. Instead, the current techniques de-couple the concept of hub preference from the data policy itself. Accordingly, the controller may create a single policy that can be applied at different branches, by enabling each branch to apply local affinity preference orders.

For instance, the controller may integrate router affinity of TLOCs when performing dynamic resolution of data policy intent. As an example, the controller may receive user instructions indicating user intent (e.g., specifying setting application traffic to go through the service chain). The controller may generate a centralized data policy that comprises a data policy action that sets a remote TLOC list. The TLOCs may be retrieved by the controller and/or based on the advertisements the controller has received from each of the hubs. In this case, when resolving the TLOCs specified in the data policy action (e.g., route traffic through the service chain), the controller carry forward the affinity group number of each TLOC in the TLOC list in the resolved TLOC information that is included in the centralized data policy sent to each branch and/or network device(s) at each branch.

In this way, with local decision making on the branches based on the locally configured affinity preference order, branches can incorporate the local affinity preference order when selecting the destinations for traffic steering. Thus, branches may automatically steer application traffic to corresponding hubs based on local affinity preference orders. Moreover, the current techniques eliminate the requirement to manually manage TLOCs across the network and multiple policies. The TLOC list automatically incorporates affinity with TLOC, resolving the need for maintaining TLOC lists and managing different policies. Accordingly, the issue of TLOC list proliferation within policies and bookkeeping is effectively resolved, as a common policy is utilized. That is, regardless of the number of hubs or the number of branches, the techniques described herein creates just one data policy (e.g., a centralized data policy), resulting in significant simplification of the network configuration to be created, managed, and/or deployed.

In some examples, the controller may generate a centralized data policy that comprises a data policy action that sets a service chain action. For instance, the controller may inherit the affinity group number of the TLOCs providing that service, when doing the service chain to TLOC resolution for the data policy action. In some examples, inheriting of affinity group numbers may occur automatically, such as where affinities are defined on the devices that originated the TLOCs (e.g., service-chain). When packets are forwarded in the data path, they are subjected to data-policies and AAR policies that now have information about TLOC affinity groups as well. When a specific application traffic matches the policy, the application traffic is directed to a TLOCs based on the affinity group number of the TLOCs and the locally configured affinity preference order on the device. And if there are multiple TLOCs sharing the same affinity group number, the system falls back to using the TLOC affinity group preference for further fine-grained and granular control over the traffic steering.

For instance, users can influence application traffic steering by enforcing local control at a branch by using local affinity preference order to choose a next-hop irrespective of HUB advertisement. While doing so, affinity preference order and TLOC affinity group preference can co-exist. For deployments where we have multiple paths with same router affinity and need fine granular control over affinity in part of the network to prefer specific TLOCs meeting SLA criteria, a user can still specify static TLOC preference. In this example, applying the data policy will enable the branch to first select paths based on local affinity preference order. Where there are multiple paths that are available with the same affinity preference order, the branch may apply the user configured static TLOC affinity group preference. With this solution, along with affinity preference order and TLOC affinity group preference, the best path selection also takes data policy and AAR policy constructs like local color preference and SLA criteria into consideration.

In this way, the system provides data policy traffic steering per local affinity-preference, thereby enabling finer control on data policy considering remote, local TLOC preference and SLA criteria. Moreover, by integrating affinity into data policies, both the control and data policies are in conformance with same affinity configuration, so they unified in their behaviors (e.g., routing and data policy now have the same behaviors) and prevent divergence and/or conflict.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

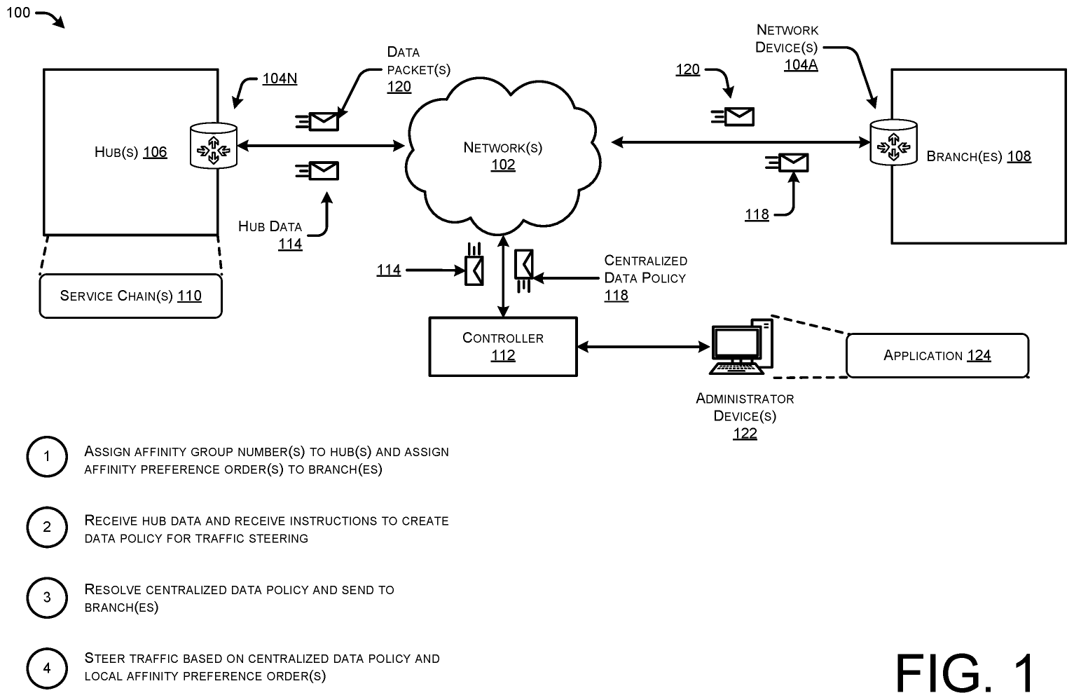

FIG. 1 illustrates a system-architecture diagram of an environment in which a system 100 can enable intent-based application traffic steering within a network. While the system 100 shows an example controller 112, it is understood that one or more of the components of the system 100 may be implemented on any device in the system.

In some examples, the system 100 may include a network 102 that includes network devices 104. The network 102 may include one or more networks implemented by any viable communication technology, such as wired and/or wireless modalities and/or technologies. The network 102 may include any combination of Personal Area Networks (PANs), software defined cloud interconnects (SDCI), Local Area Networks (LANs), Campus Area Networks (CANs), Metropolitan Area Networks (MANs), extranets, intranets, the Internet, short-range wireless communication networks (e.g., ZigBee, Bluetooth, etc.), Wide Area Networks (WANs)—both centralized and/or distributed, software defined WANs (SDWANs)—and/or any combination, permutation, and/or aggregation thereof. The network 102 may include devices, virtual resources, or other nodes that relay packets from one network segment to another by nodes in the computer network. The network 102 may include multiple devices that utilize the network layer (and/or session layer, transport layer, etc.) in the OSI model for packet forwarding, and/or other layers.

The system 100 may comprise a controller 112. In some examples, the controller 112 corresponds to a system that has complete visibility into the security fabric of a given network (e.g., enterprise network, smaller network, etc. In some examples, the controller 112 may comprise a memory, one or more processors, etc. In some examples, the controller 112 may comprise a routing controller. In some examples, the controller 112 may be integrated as part of Cisco's vSmart feature, Cisco's vManage feature, and/or included in a SDWAN architecture.

The controller 112 may be configured to communicate with one or more network device(s) 104. For instance, the controller 112 may receive network data (e.g., network traffic load data, network client data, etc.) or other data (e.g., application load data, data associated with WLCs, APs, etc.) from the network device(s) 104. The network device(s) 104 may comprise routers, switches, access points, stations, radios, and/or any other network device. In some examples, the network device(s) 104 may monitor traffic flow(s) within the network and may report information associated with the traffic flow(s) to the controller 112.

In some examples, the system comprises branch(es) 108 and/or hub(s) 106. In some examples, the branch(es) 108 comprise one or more user(s), mobile device(s), and/or Internet of Things (IoT) device(s) located at one or more locations. In some examples, the hub(s) 106 may comprise one or more network device(s) 104, gateway device(s) (also referred to herein as “gateways”), tunneling interfaces, etc. In some examples, the hub(s) 106 may comprise service chain(s) 110. For instance, each hub 106 may host a service chain 110. In some examples, the service chain(s) 110 may comprise a firewall service, or other service.

In some examples, the branch(es) 108 communicate via network device(s) 104. In some examples, the network device(s) 104 may correspond to edge device(s) In some examples, the network device(s) 104 may comprise a SDCI router and/or headend device. In some examples, the branch(es) 108 and/or hub(s) 106 communicate with each other, the controller 112, and/or cloud providers (e.g., SaaS, Internet, IaaS, etc.) via the network(s) 102.

In some examples, the network device(s) 104 may communicate information. For instance, the network device(s) 104 may send data packet(s) 120 associated with data flows to other network device(s). In some examples, the data packet(s) 120 and/or metadata associated with the data packet(s) 120 may be sent to and/or monitored by the controller 112.

In some examples, the controller 112 may be configured to monitor the data packets 120. In some examples, the data packets may comprise data (e.g., which application is used, by which station, traffic characteristics and duration, etc.) associated with network traffic and may store the data as part of the system and/or controller 112 (e.g., such as in a database and/or memory associated with the controller 112).

In some examples, the controller 112 is configured to receive hub data 114 from the hub(s) 106. In some examples, the hub data 114 comprises advertisement(s) from each of the hub(s) 106. In some examples, the advertisement(s) comprise TLOC information associated with the service chain 110 and/or affinity group number(s) associated with each hub 106.

In some examples, the controller 112 may send a centralized data policy 118 to the hub(s) 106 and/or branch(es) 108. In some examples, the centralized data policy 118 may comprise integrated router affinity of TLOCs when performing dynamic resolution of data policy intent. For instance, the centralized data policy 118 may include the affinity group number of each TLOC in the TLOC list and the user intent. In some examples, the centralized data policy 118 may comprise a data policy action that sets a remote TLOC list and/or a data policy action that sets a service chain action.

In some examples, the controller 112 may be configured to communicate with administrator device(s) 122. As illustrated, the administrator device(s) 122 may comprise an application 124. In some examples, the application 124 may correspond to an application provided by a service provider (e.g., such as Cisco) that enables an administrator of the network 102 to access the controller 112. For instance, the application 124 may correspond to Cisco's vSmart feature and/or Cisco's vManage feature.

In some examples, administrator device(s) 122 may send configuration information to the controller 112, hub(s) 106, and/or branch(es) 108. In some examples, the configuration information may comprise affinity group number(s) associated with the hub(s) and/or affinity preference order(s) assigned to each of the branch(es) 108.

At “1”, the system may assign affinity group number(s) to hub(s) and assign affinity preference order(s) to branch(es). For instance, the system may assign and/or configure a first hub to have the affinity group number 1. The system may assign and/or configure a second hub to have the affinity group number 2. In some examples, each route originating from a particular hub may be tagged with the configured and/or assigned affinity group number (e.g., route(s) from the first hub are tagged with the affinity group number 1, etc.). In some examples, a user may assign and/or configure affinity group numbers of the one or more hub(s) 106 and/or the affinity preference order(s) of branch(es) 108 during configuration of the network. In some examples, an affinity preference order may be assigned to each branch and/or network device of each branch as an ordered list. For instance, affinity preference order(s) may be configured and/or assigned to each branch by a network administrator, such as during configuration of the network. In some examples, a first edge device may be configured to have an affinity preference order of [1,2]. In this example, the first branch is configured to prefer routing traffic to a first hub with the affinity group number 1 first. In some examples, such as in the absence of the first hub tagged with the affinity group number 1, the first branch may then failover to a second hub tagged with affinity group number 2 and so on. In some examples, a second branch may be configured to have an affinity preference order of [2,1]. In this example, the second branch is configured to prefer routing traffic to a second hub tagged with affinity group number 2 first. In some examples, such as in the absence of the second hub assigned with the affinity group number 2, the second branch may then failover to the first hub assigned with affinity group number 1 and so on. In some examples, the system may store affinity preference orders locally at each branch.

At “2”, the system may receive hub data and instructions to create a data policy for traffic steering. For instance, the hub data may comprise hub data 114 described above. In some examples, the instructions may be received via an application associated with a service provider (e.g., such as Cisco, via vSmart, etc.). In some examples, the instructions may comprise an indication of user intent. For instance, user intent may indicate that application traffic at a first hub and a second hub will undergo the service chain. In this example, and in contrast to existing techniques, the user does not need to specify TLOCs or data policies for each of the hubs and/or branches. Instead, the controller may configure the centralized data policy. Moreover, in contrast to existing techniques, a user does not need to define TLOCs statically and/or create multiple data policies for each branch. Instead, the current techniques de-couple the concept of hub preference from the data policy itself. Accordingly, the controller may create a single policy that can be applied at different branches, by enabling each branch to apply local affinity preference orders.

At “3”, the system may resolve a centralized data policy and send the centralized data policy to the branch(es). For instance, the controller 112 may automatically resolve user intent (e.g., traffic sent through a service chain 110) with TLOCs and affinity group numbers. In some examples, the controller generates the centralized data policy as part of the resolution process. Thurs, the controller integrates affinity (e.g., affinity group numbers) of TLOCs with data policies and application event policies dynamically and automatically. As noted above, the centralized data policy 118 may comprise a data policy action that sets a remote TLOC list, a data policy action that sets a service chain action, and/or any other data policy action. In some examples, the controller 112 may send and/or push the centralized data policy to the branch(es) 108.

At “4”, the system may steer traffic based on the centralized data policy and local affinity preference order(s). For instance, each branch 108 may implement and apply local affinity preference orders to the centralized data policy. Accordingly, each branch may have full policy intent, such that the branches can utilize local affinity preference orders when sending traffic to corresponding hub.

In this way, the system may enable branches to implement router affinity group support within the data policy, thereby avoiding the need to bookkeep TLOC lists. That is, by de-coupling the concept of hub preference from the data policy itself, users no longer need to define hub preference and/or TLOCs when defining a data policy. Thus, by de-coupling the current techniques enable a single data policy to be applied to different branches, regardless of the number of hubs or the number of branch groupings. This results in significant simplification of the configuration to be created/managed/deployed. Moreover, de-coupling enables branches to automatically, based on local affinity preference orders, identify which TLOC and/or hub to prefer.

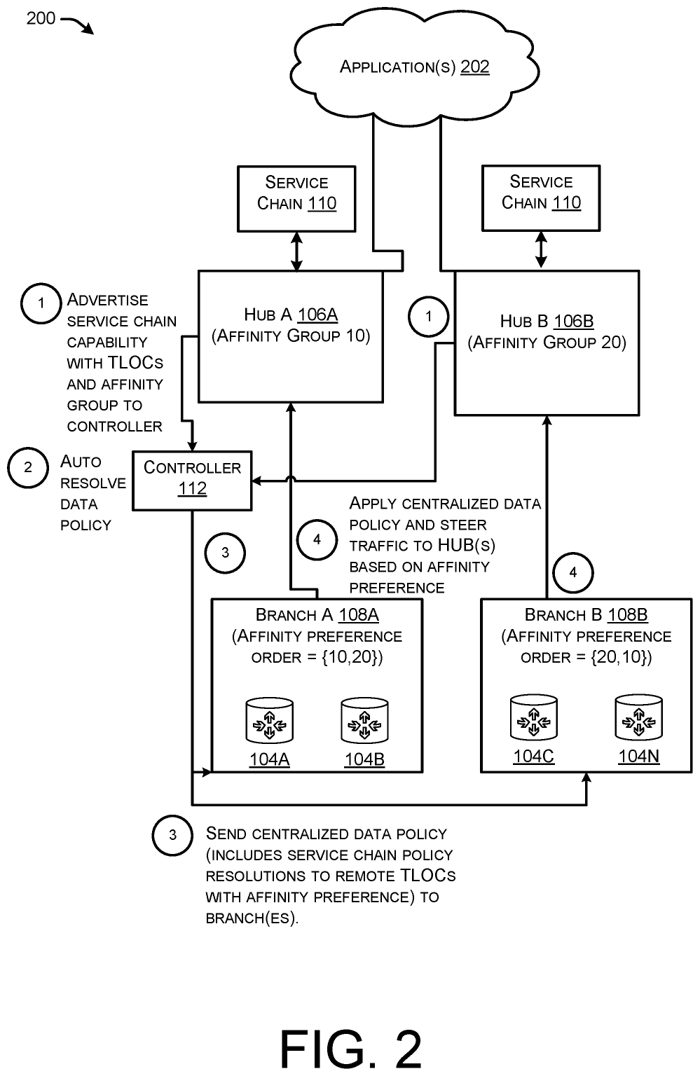

FIG. 2 illustrates an example environment 200 associated with the system described in FIG. 1. In some examples, environment 200 corresponds

In some examples, the environment 200 may include a network 102 that comprises application(s) 202. For instance, application(s) 202 may correspond to one or more cloud-based applications that a user at a branch 108 may want to access via network(s) 102. Examples of application(s) 202 may include, but are not limited to, Webex, Microsoft 365, Google, Dropbox, Salesforce, etc.

As illustrated, the example environment 200 comprises a first hub (Hub A 106A and a second hub (Hub B 106B). In some examples, Hub A 106A may represent a western hub and Hub B 106B may represent an eastern hub. As illustrated, Hub A 106A and Hub B 106B each host a service chain 110. In the illustrated example, Hub A 106A is assigned to affinity group 10 and Hub B is assigned to affinity group 20.

The example environment 200 further comprises a first branch (Branch A 108A) and a second branch (Branch B 108B). In some examples, Branch A 108A may represent a western branch and Branch B 108B may represent an eastern branch. As illustrated, Branch A 108A is configured to have an affinity preference order of [10,20] and Branch B is configured to have an affinity preference order of [20,10].

As noted above, in existing techniques there was no way for a branch to exert local control over application traffic steering based on local branch preferences rather than adhering to the TLOC preferences advertised by the central hub. In the illustrated environment 200, Hub A 106A has a TLOC preference of 10 and Hub B 106B has a TLOC preference of 20. In existing techniques, the higher the preference value, the more preferred the Hub is. However, existing techniques do not provide per branch device local preference control. Accordingly, with existing mechanisms, both Branch A 108A and Branch B 108B prefer Hub B 106B, which can be against user intent of selecting a co-located hub (e.g., implementing affinity preference orders at each branch and/or for each network device 104 at each branch 108). Accordingly, the techniques described herein enable a centralized data policy to use the affinity group numbers of the Hub routers and prefer regional (e.g., co-located) Hubs based on local affinity preference order of the branches.

At “1”, Hub A 106A and Hub B 106B each advertise their respective service chain capabilities with TLOCs and respective affinity group numbers to the controller 112. For instance, Hub A 106A advertises service chain capabilities with TLOCs and affinity group 10. Hub B 106B advertises service chain capabilities with TLOCs and affinity group 20.

At “2”, the controller 112 may receive user intent and auto resolve the data policy. For instance, the controller may receive a user intent to match application traffic at branches and steer the application traffic to service chain 110. The controller 112 may automatically and dynamically resolve the data policy to create the centralized data policy. For instance, the controller 112 may resolve the data policy action with service chain to TLOCs along with the affinity group numbers. As an example, the data policy action may include setting a remote-TLOC-list. In this case, when resolving the TLOCs specified in the data policy action, the controller 112 may carry forward the affinity of each TLOC in the TLOC list in the resolved-TLOC information that it sends to the network device(s) 104 at each branch. Additionally or alternatively, the data policy action may including sets a service-chain action. In this case the controller 112 may generate the centralized data policy where the centralized data policy inherits the affinity of the TLOCs providing that service, when doing the service chain to TLOC resolution for the data-policy action. In some examples, inheriting of affinity may occur automatically where affinities are defined on the network devices that originated the TLOCs and/or service chain.

At “3”, the controller 112 may send the centralized data policy (including the service chain policy resolutions to remote TLOCs with affinity group preference) to each of Branch A 108A and Branch B 108B.

An example of the centralized data policy that may be created by the controller 112 and applied to multiple branches 108 includes:

```
policy
  data-policy dp1
  vpn-list vpn_1
  sequence 10
    match
    app-list ms-office
    !
    action accept
    set
      service-chain SC1 vpn 101
```

An example of the centralized data policy that is downloaded by each of the branches 108 may include:

| policy | |
|---|---|
| data-policy dp1 | |
| vpn-list vpn_1 | |
| sequence 10 | |
| match | |
| app-list ms-office | |
| ! | |
| action accept | |
| set | |
| vip-tloc-pref-list 1 | |
| tloc-label | 8389624 |
| tloc-ip | 172.16.255.40 |
| tloc-color | biz-internet |
| tloc-encap | ipsec |
| tloc-affinity-group 10 | |
| vip-tloc-pref-list 3 | |
| tloc-label | 8389614 |
| tloc-ip | 172.16.255.41 |
| tloc-color | biz-internet |
| tloc-encap | ipsec |

tloc-affinity-group 20

At “4”, each of the branch(es) 108 may apply the centralized data policy and steer traffic to the hub(s) 106 based on affinity preference. For instance, when data packets are forwarded in the data path, they are subjected to data policies and AAR policies that now have information about TLOC affinities as well. As an example, when a network device 104A at Branch A determines that specific application traffic matches the centralized data policy, the specific application traffic is directed to a TLOC based on the affinity of the TLOC and the locally configured affinity preference order of Branch A 108A and/or network device 104A. Accordingly, in contrast to existing techniques, the specific application traffic may be steered to Hub A 106A, thereby matching user intent. Further, where there are multiple TLOCs sharing the same affinity group number, Branch A may fall back to using the TLOC preference for further fine-grained and granular control over the traffic steering.

With local decision making on the branches based on the locally configured affinity preference order, branches can incorporate the local affinity preference order when selecting the destinations for traffic steering. E.g., Branch A 108A may steer to Hub A 106A and Branch B 108B may steer to Hub B 106B. This solution eliminates the requirement to manually manage TLOCs across the network and multiple policies. The TLOC list automatically incorporates affinity with TLOC, resolving the need for maintaining TLOC lists and managing different policies.

The issue of TLOC list proliferation within policies and bookkeeping is effectively resolved, as a common policy is utilized. Affinity simplifies the visualization of preferences at the router level, working seamlessly and making it easy for customers.

In some examples, a user can control the advertised affinity from a router globally “affinity-group-number” or per vrf level via “affinity-per-vrf”. Accordingly, data policy affinity may be incorporated and applied at a per VRF and/or per VPN level as well.

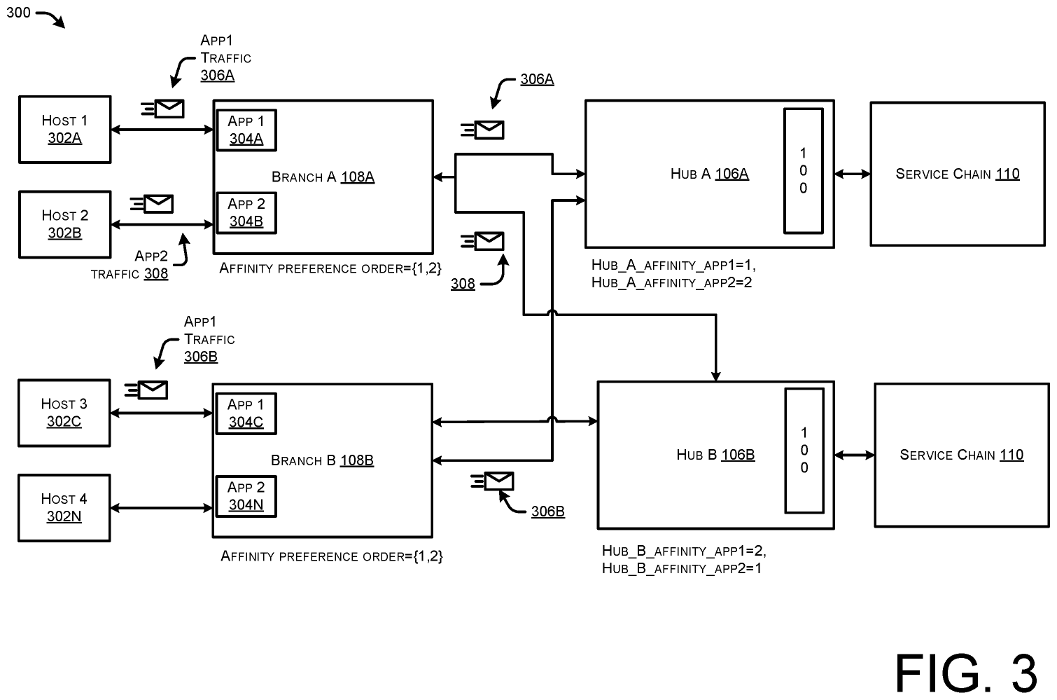

FIG. 3 illustrates an example environment 300 associated with the system described in FIGS. 1-2. In some examples, the environment 300 illustrates an example of path preference via data policy using per application affinity preference. For example, existing techniques do not provide support in data policies for steering application traffic using affinity preference on a per application basis. For example, when accessing a first application (e.g., such as outlook, a user may want an affinity preference order of [1,2]. When accessing a second application (e.g., such as Google), the user may want an affinity preference order of [2,1]. However, existing techniques do not provide support for affinity in data policies, accordingly, branch(es) 108 are not able to match a data packet with some criteria (e.g., application type, etc.) and implement an affinity based preference when steering the data packet.

With the techniques described herein, branch(es) 108 can apply the centralized data policy and perform application traffic steering on a per application basis. In the environment illustrated in FIG. 3, the system may implement path preference via data policy using per virtual routing and forwarding (VRF) affinity preference, per virtual private network (VPN) affinity preference, etc.

In the illustrated example, the environment 300 includes Branch A 108A, Branch B 108B, Hub A 106A, Hub B 106B, and service chain(s) 110. Additionally the environment 300 includes Host 1 302A, Host 2 302B, Host 3 302C, and Host 4 302N. In some examples, each of the host(s) 302 may represent an end user. For instance, host 1 302A may represent a first end user connecting to application 1 304A at Branch A 108A. In some examples, application 1 304A comprises a VPN application, a VRF application, etc. In some examples, application 1 304A represents a first VRF connection and application 2 304B represents a second VRF connection. In some examples, Branch A 108A and Branch B 108B are connected to Hub A 106A and Hub B 106B via network(s) 102. In some examples, network(s) 102 corresponds to a multiprotocol label switching (MPLS) internet connection.

In the illustrated example, Hub A 106A is configured to have affinity for application 1 304A be 1 (e.g., “Hub_A_affinity_App1=1”) and affinity for application 2 304B be 2 (e.g., “Hub_A_affinity_App2=2”). Hub B 106B is configured to have affinity for application 1 304C be 1 (e.g., “Hub_B_affinity_App1=2”) and affinity for application 2 304N be 2 (e.g., “Hub_B_affinity_App2=1”). As illustrated, the affinity preference order at each of Branch A 108A and Branch B 108B is [1,2].

In the illustrated environment 200, a centralized data policy may indicate user intent to steer application traffic to the service chain 110. Accordingly, Branch A 108A may steer app1 traffic 306A to Hub A 106A and app2 traffic 308 to Hub B 108B. As illustrated, Branch B 108B may also steer app1 traffic 306B to Hub A 106A.

In contrast to existing techniques, where a user would need to create multiple data policies per application (e.g., per VPN, per VRF, etc.) and specify preferences for each policy, the current techniques enable a user to only need to create a single policy per application (e.g., per VPN, per VRF, etc.).

Moreover, the techniques described herein enable data policy traffic steering per local affinity preference order, resulting in finer control on data policies, such that the branch(es) 108 may consider remote TLOC preference, local TLOC preference, and/or SLA criteria when steering traffic. With the techniques described herein, users can influence application traffic steering on a per application basis. The techniques described herein may do so by enforcing local control at the branch(es) 108 by using an affinity preference order to choose next-hop irrespective of Hub advertisement. While doing so, affinity and TLOC preference can co-exist. For deployments where there are multiple paths with the same router affinity and there is a need for fine granular control over affinity in a specific part of the network (e.g., prefer specific TLOCs meeting SLA criteria), the user may specify static TLOC-preference. In this example, application of the centralized data policy may first select paths based on affinity and where there are multiple paths that are available with same router affinity, then it can apply user configured static TLOC preference. With the claimed techniques, along with affinity and TLOC preference, the centralized data policy can be applied on a per application basis. Further, best path selection may further take data policy and AAR policy constructs like local color preference and SLA criteria into consideration.

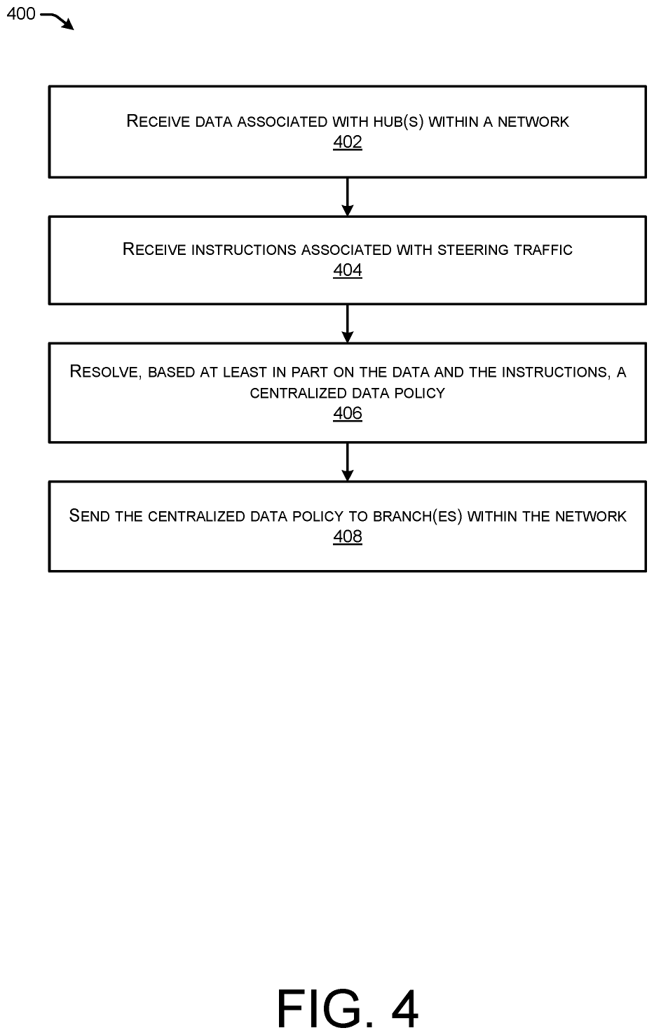

FIG. 4 illustrates a flow diagram of an example system 400 for enabling intent-based application traffic steering in a network. In some instances, the steps of system 400 may be performed by one or more devices (e.g., controller 112, network device(s) 104, etc.) that include one or more processors and one or more non-transitory computer-readable media storing computer-executable instructions that, when executed by the one or more processors, cause the one or more processors to perform operations of system 400.

At 402, the system may receive data associated with hub(s) within a network. In some examples, the data comprises hub data 114 described above. In some examples, a service chain is hosted at each of the one or more hubs. In some examples, the service chain comprises a firewall service. For instance, the data associated with the hub(s) may comprise TLOC data associated with the service chain at each of the hub(s) and affinity group numbers associated with each of the hub(s).

At 404, the system may receive instructions associated with steering traffic. In some examples, the system may receive the instructions from an application executing on a user device. For instance, the application may correspond to application 124. In some examples, the instructions indicate an intent to match application traffic at the one or more branches and steer the application traffic to the service chain.

At 406, the system may resolve, based at least in part on the data and the instructions, a centralized data policy. In some examples, resolving the centralized data policy comprises updating a TLOC list to incorporate the affinity group numbers associated with each of the one or more hubs and a corresponding TLOC associated with the service chain.

At 408, the system may send the centralized data policy to branch(es) within the network. In some examples, the centralized data policy enables the first branch within the network to route traffic to a first hub of the one or more hubs and the second branch within the network to route traffic to a second hub of the one or more hubs based at least in part on a first affinity preference order associated with the first branch or a second affinity preference order associated with the second branch. In some examples, the centralized data policy enables the first branch within the network to route traffic to a first hub of the one or more hubs according to an affinity preference order local to the first branch and on a per application basis.

In this way, with local decision making on the branches based on the locally configured affinity preference order, branches can incorporate the local affinity preference order when selecting the destinations for traffic steering. Thus, branches may automatically steer application traffic to corresponding hubs based on local affinity preference orders. Moreover, the current techniques eliminate the requirement to manually manage TLOCs across the network and multiple policies. The TLOC list automatically incorporates affinity with TLOC, resolving the need for maintaining TLOC lists and managing different policies. Accordingly, the issue of TLOC list proliferation within policies and bookkeeping is effectively resolved, as a common policy is utilized. That is, regardless of the number of hubs or the number of branches, the techniques described herein creates just one data policy (e.g., a centralized data policy), resulting in significant simplification of the network configuration to be created, managed, and/or deployed. Moreover, the system provides data policy traffic steering per local affinity-preference, thereby enabling finer control on data policy considering remote, local TLOC preference and SLA criteria. Moreover, by integrating affinity into data policies, both the control and data policies are in conformance with same affinity configuration, so they unified in their behaviors (e.g., routing and data policy now have the same behaviors) and prevent divergence and/or conflict.

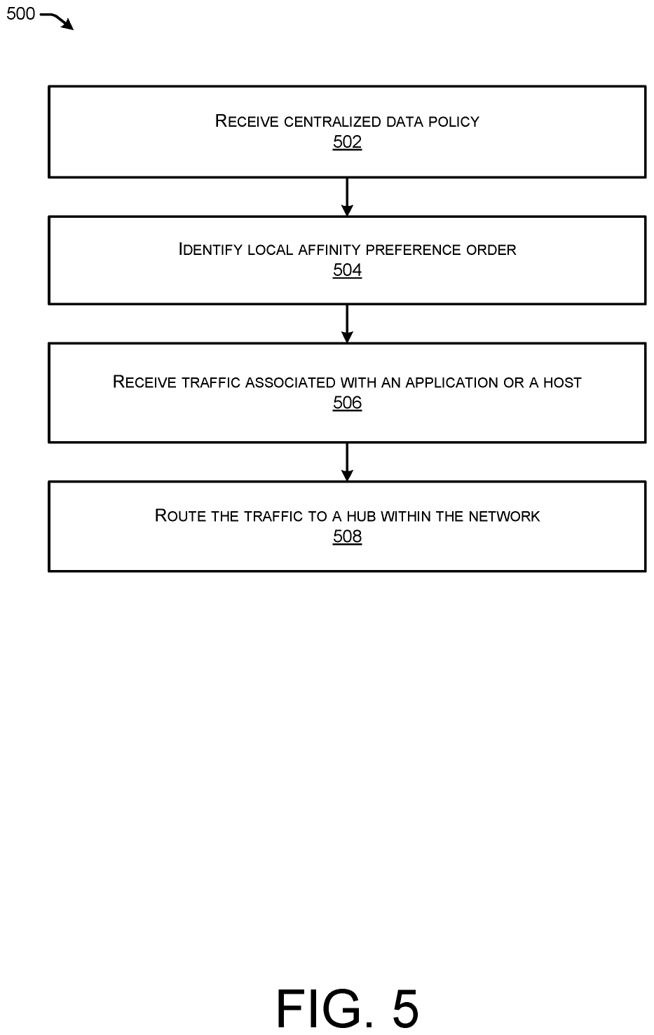

FIG. 5 illustrates a flow diagram of an example system 400 for enabling intent-based application traffic steering within a network. In some instances, the steps of system 400 may be performed by one or more devices (e.g., controller 112, branch(es) 108, network device(s) 104, etc.) that include one or more processors and one or more non-transitory computer-readable media storing computer-executable instructions that, when executed by the one or more processors, cause the one or more processors to perform operations of system 500.

At 502, the system may receive a centralized data policy. For instance, the centralized data policy may be resolved and/or generated by a controller of the network. In some examples, the centralized data policy a TLOC list that includes affinity group numbers associated with one or more hubs and a corresponding TLOC associated with a service chain hosted at each of the one or more hubs. In some examples, the centralized data policy comprises a user intent and/or data policy action.

At 504, the system may identify a local affinity preference order. For instance, a branch and/or network device may be configured to have one or more affinity preference order(s). The system may, in response to receiving the centralized data policy, access the local affinity preference order, such that the branch and/or network device can apply the local affinity preference order and the centralized data policy.

At 506, the system may receive traffic associated with an application or a host. For instance, the system may receive application traffic associated with an application. In some examples, the system may receive traffic associated with a VRF, VPN, etc.

At 508, the system may route the traffic to a hub within the network. In some examples, routing the traffic to the hub is on a per application or a per host basis. In some examples, routing the traffic is further based at least in part on one or more of a local TLOC preference or SLA criteria.

In this way, with local decision making on the branches based on the locally configured affinity preference order, branches can incorporate the local affinity preference order when selecting the destinations for traffic steering. Thus, branches may automatically steer application traffic to corresponding hubs based on local affinity preference orders. Moreover, the current techniques eliminate the requirement to manually manage TLOCs across the network and multiple policies. The TLOC list automatically incorporates affinity with TLOC, resolving the need for maintaining TLOC lists and managing different policies. Accordingly, the issue of TLOC list proliferation within policies and bookkeeping is effectively resolved, as a common policy is utilized. That is, regardless of the number of hubs or the number of branches, the techniques described herein creates just one data policy (e.g., a centralized data policy), resulting in significant simplification of the network configuration to be created, managed, and/or deployed. Moreover, the system provides data policy traffic steering per local affinity-preference, thereby enabling finer control on data policy considering remote, local TLOC preference and SLA criteria. Moreover, by integrating affinity into data policies, both the control and data policies are in conformance with same affinity configuration, so they unified in their behaviors (e.g., routing and data policy now have the same behaviors) and prevent divergence and/or conflict.

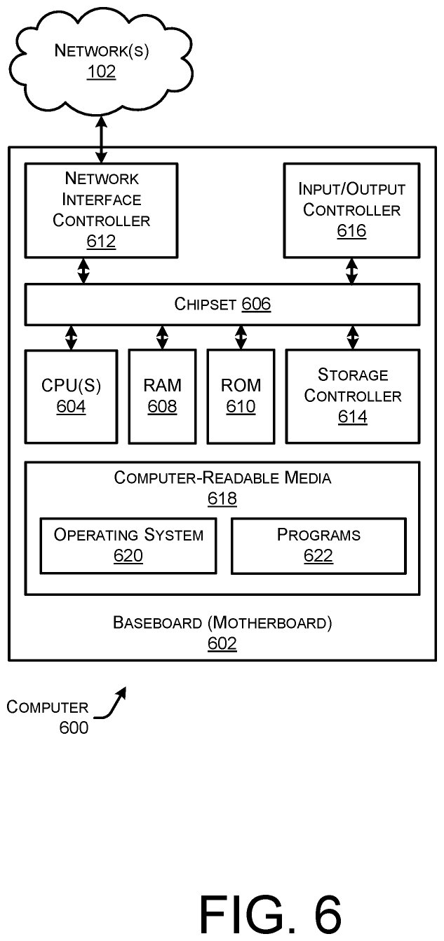

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer may, in some examples, correspond to a controller 112, a hub 106, a branch 108, a network device 104, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like. The chipset 606 provides an interface between the CPUs 604 and the remainder

of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as network(s) 102. The chipset 606 can include functionality for providing network connectivity through a NIC 612, such as a gigabit Ethernet adapter. The NIC 612 is capable of connecting the computer 600 to other computing devices over the network(s) 102. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the correspond to the controller 112, the hub 106, the branch 108, the network device 104, and/or any components included therein, may be supported by one or more devices similar to computer 600. Stated otherwise, some or all of the operations performed by the controller 112, the hub 106, the branch 108, the network device 104, and/or any components included therein, may be performed by one or more computers 600.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of a controller 112, a hub 106, a branch 108, a network device 104, and/or any other device. The computer 600 may include one or more hardware processors (e.g., such as CPUs 604 (processors)) configured to execute one or more stored instructions. The processor(s) may comprise one or more cores. Further, the computer 600 may include one or more network interfaces configured to provide communications between the computer 600 and other devices, such as the communications described herein as being performed by the controller 112, the hub 106, the branch 108, the network device 104. The network interfaces may include devices configured to couple to personal area networks (PANs), user defined networks (UDNs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure for improving network convergence within data center network fabrics. For instance, the programs 622 may cause the computer 600 to perform techniques including receiving, from one or more hubs within the network, data associated with the one or more hubs; receiving, from an application on a user device, instructions associated with steering traffic within the network; resolving, based at least in part on the data and the instructions, a centralized data policy; sending, to a first branch within the network, the centralized data policy; and sending, to a second branch within the network, the centralized data policy.

Additionally, or alternatively the programs 622 may cause the computer 600 to perform techniques including: receiving, from a controller of the network, a centralized data policy; identifying a local affinity preference order associated with an application or a host; receiving traffic associated with the application or the host; and routing the traffic to a hub within the network based at least in part on the centralized data policy and the local affinity preference order.

In this way, with local decision making on the branches based on the locally configured affinity preference order, branches can incorporate the local affinity preference order when selecting the destinations for traffic steering. Thus, branches may automatically steer application traffic to corresponding hubs based on local affinity preference orders. Moreover, the current techniques eliminate the requirement to manually manage TLOCs across the network and multiple policies. The TLOC list automatically incorporates affinity with TLOC, resolving the need for maintaining TLOC lists and managing different policies. Accordingly, the issue of TLOC list proliferation within policies and bookkeeping is effectively resolved, as a common policy is utilized. That is, regardless of the number of hubs or the number of branches, the techniques described herein creates just one data policy (e.g., a centralized data policy), resulting in significant simplification of the network configuration to be created, managed, and/or deployed. Moreover, the system provides data policy traffic steering per local affinity-preference, thereby enabling finer control on data policy considering remote, local TLOC preference and SLA criteria. Moreover, by integrating affinity into data policies, both the control and data policies are in conformance with same affinity configuration, so they unified in their behaviors (e.g., routing and data policy now have the same behaviors) and prevent divergence and/or conflict.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method implemented by a controller of a network, the method comprising:
receiving, from one or more hubs within the network, data associated with the one or more hubs;
receiving, from an application on a user device, instructions associated with steering traffic within the network;
resolving, based at least in part on the data and the instructions, a centralized data policy;
sending, to a first branch within the network, the centralized data policy; and
sending, to a second branch within the network, the centralized data policy.

2. The method of claim 1, wherein the data associated with the one or more hubs comprises TLOC data associated with a service chain at each of the one or more hubs and affinity group numbers associated with each of the one or more hubs.

3. The method of claim 2, wherein resolving the centralized data policy comprises updating a TLOC list to incorporate the affinity group numbers associated with each of the one or more hubs and a corresponding TLOC associated with the service chain.

4. The method of claim 1, wherein a service chain is hosted at each of the one or more hubs.

5. The method of claim 4, wherein the instructions indicate an intent to match application traffic at the first branch and the second branch and steer the application traffic to the service chain.

6. The method of claim 4, wherein the service chain comprises a firewall service.

7. The method of claim 1, wherein the centralized data policy enables the first branch within the network to route traffic to a first hub of the one or more hubs and the second branch within the network to route traffic to a second hub of the one or more hubs based at least in part on a first affinity preference order associated with the first branch or a second affinity preference order associated with the second branch.

8. The method of claim 1, wherein the centralized data policy enables the first branch within the network to route traffic to a first hub of the one or more hubs according to an affinity preference order local to the first branch and on a per application basis.

9. A system comprising:
one or more processors; and
one or more computer-readable media storing instructions that, when executed by the one or more processors, cause the one or more processors to perform operations comprising:
receiving, by a controller of a network and from one or more hubs within the network, data associated with the one or more hubs;
receiving, by the controller and from an application on a user device, instructions associated with steering traffic within the network;
resolving, by the controller and based at least in part on the data and the instructions, a centralized data policy;
sending, from the controller and to a first branch within the network, the centralized data policy; and
sending, from the controller and to a second branch within the network, the centralized data policy.

10. The system of claim 9, wherein the data associated with the one or more hubs comprises TLOC data associated with a service chain at each of the one or more hubs and affinity group numbers associated with each of the one or more hubs.

11. The system of claim 10, wherein resolving the centralized data policy comprises updating a TLOC list to incorporate the affinity group numbers associated with each of the one or more hubs and a corresponding TLOC associated with the service chain.

12. The system of claim 9, wherein a service chain is hosted at each of the one or more hubs.

13. The system of claim 12, wherein the instructions indicate an intent to match application traffic at the first branch and the second branch and steer the application traffic to the service chain.

14. The system of claim 12, wherein the service chain comprises a firewall service.

15. The system of claim 9, wherein the centralized data policy enables the first branch within the network to route traffic to a first hub of the one or more hubs and the second branch within the network to route traffic to a second hub of the one or more hubs based at least in part on a first affinity preference order associated with the first branch or a second affinity preference order associated with the second branch.

16. The system of claim 9, wherein the centralized data policy enables the first branch within the network to route traffic to a first hub of the one or more hubs according to an affinity preference order local to the first branch and on a per application basis.

17. A method implemented at least in part by a device at a branch within a network, the method comprising:
receiving, from a controller of the network, a centralized data policy;
identifying a local affinity preference order associated with an application or a host;
receiving traffic associated with the application or the host; and
routing the traffic to a hub within the network based at least in part on the centralized data policy and the local affinity preference order.

18. The method of claim 17, wherein the centralized data policy comprises a TLOC list that includes affinity group numbers associated with one or more hubs and a corresponding TLOC associated with a service chain hosted at each of the one or more hubs.

19. The method of claim 17, wherein routing the traffic to the hub is on a per application or a per host basis.

20. The method of claim 17, wherein routing the traffic is further based at least in part on one or more of a local TLOC preference or SLA criteria.
